(19) United States
(12) Patent Application Publication
(10) Pub. No.: US 2024/0116191 A1
(43) Pub. Date: Apr. 11, 2024

(54) ROBOT CONTROL DEVICE, ROBOT CONTROL SYSTEM, AND ROBOT CONTROL METHOD

(71) Applicant: FANUC CORPORATION, Minamitsuru-gun, Yamanashi (JP)

(72) Inventor: Tomoki KATO, Yamanashi (JP)

(21) Appl. No.: 18/276,996

(22) PCT Filed: Apr. 1, 2021
(86) PCT No.: PCT/JP2021/014184

§ 371 Date: Aug. 11, 2023

(51) Int. Cl. B25J 13/06; B25J 9/16; G05B 19/045

(52) U.S. Cl. CPC B25J 13/06; B25J 9/1664; G05B 19/045

(57) ABSTRACT

Provided is a robot control device that eliminates the need to alternate between a transfer operation executed with a robot teaching operation panel and a confirmation operation executed with a screen of a programmable logic controller. This robot control device is connected to a programmable logic controller and controls a robot, wherein the robot control device is provided with: a transfer unit that transfers a current position of the robot to the programmable logic controller in order to store the current position in a prescribed region within the programmable logic controller; an acquisition unit that acquires, from the programmable logic controller, the current position stored in the programmable logic controller or information related to the current position; and a display control unit that displays the acquired current position or information related to the current position to a screen of a robot teaching operation panel.

### TECHNICAL FIELD

The present invention relates to a robot control apparatus, a robot control system, and a robot control method, and in particular to a robot control apparatus connected to a programmable logic controller (hereinafter referred to as a PLC) to control a robot, a robot control system, and a robot control method.

### BACKGROUND ART

Recently, systems causing a robot to make motions with a PLC program have been widely adopted, as represented by the PLCopen standard. In order to cause a robot to make motions from a PLC, it is necessary that a robot control apparatus transfers the current position of the robot to the PLC, and the PLC stores the current position in the PLC. A user is required to perform work of, after operating a robot teaching operation panel to transfer the current position of the robot to the PLC, confirming whether the current position has been stored or not on the screen of the PLC.

A system including a PLC and a robot control apparatus is described, for example, in Patent Document 1. In Patent Document 1, a robot simulation apparatus is described which is capable of performing operation simulation of the entire system in which a robot and peripheral equipment are combined. In the robot simulation apparatus, a PC specifies a robot based on robot identification information, and a specified robot control apparatus reads a teaching operation program and stores the teaching operation program into the memory of the PC. Next, the operation program is executed by the robot control apparatus specified based on the robot identification information; a sequence program corresponding to the robot identification information is executed in the PLC; I/O data to/from peripheral equipment such as a welding machine is captured into the PC; and a control history is stored. Then, robot animation is displayed on the display screen of a graphic display device of the PC based on information from the robot control apparatus and information from the PLC, and operation state information about the peripheral equipment is also displayed.
Patent Document 1: Japanese Unexamined Patent Application, Publication No. 2003-117863

### DISCLOSURE OF THE INVENTION

### Problems to be Solved by the Invention

There is a problem that, at the time of operating the robot teaching operation panel to transfer the current position of the robot to the PLC and store the current position, the user has to alternately perform a transfer operation on the robot teaching operation panel and a confirmation operation on the screen of the PLC, which requires much time.

### Means for Solving the Problems

(1) A first aspect of the present disclosure is a robot control apparatus connected to a programmable logic controller to control a robot, the robot control apparatus including: a transfer unit transferring a current position of the robot to the programmable logic controller to store the current position into a predetermined area in the programmable logic controller; an acquisition unit acquiring, from the programmable logic controller, the current position stored in the programmable logic controller or related information about the current position; and a display control unit displaying the current position or the related information that has been acquired, on a screen of a robot teaching operation panel.

(2) A second aspect of the present disclosure is a robot control system including the robot control apparatus according to (1) above and a programmable logic controller connected to the robot control apparatus.

(3) A third aspect of the present disclosure is a robot control method for controlling a robot using a programmable logic controller and a robot control apparatus connected to the programmable logic controller, the robot control method including: the robot control apparatus transferring a current position of the robot to the programmable logic controller to store the current position into a predetermined area in the programmable logic controller; the robot control apparatus acquiring, from the programmable logic controller, the current position stored in the programmable logic controller or related information about the current position; and the robot control apparatus displaying the current position or the related information that has been acquired, on a screen of a robot teaching operation panel.

### Effects of the Invention

According to each aspect of the present disclosure, it becomes unnecessary to, at the time of transferring a current position of a robot to a PLC to store the current position, alternately perform a transfer operation on a robot teaching operation panel and a confirmation operation on the screen of the PLC, and it is possible to perform a series of operations only with the robot teaching operation panel.

### BRIEF DESCRIPTION OF THE DRAWINGS

FIG. 1 is a block diagram showing a configuration example of a robot control system including a robot control apparatus of a first embodiment of the present disclosure;

FIG. 2 is a block diagram showing a configuration of the robot control apparatus of the first embodiment;

FIG. 3 is a flowchart showing operation of the robot control apparatus of the first embodiment;

FIG. 4 is a diagram showing change in display information on the screen of a robot teaching operation panel and in storage information about a position array of the PLC.

FIG. 5 is a diagram showing display information on the screen of the robot teaching operation panel and storage information on the PLC in a second embodiment of the present disclosure.

FIG. 6 is a diagram showing a confirmation popup displayed on the screen of the robot teaching operation panel by a robot control apparatus of a third embodiment of the present disclosure; and

FIG. 7 is a flowchart showing operation of the robot control apparatus of the third embodiment.

### PREFERRED MODE FOR CARRYING OUT THE INVENTION

Embodiments of the present invention will be described below in detail using drawings.

### FIRST EMBODIMENT

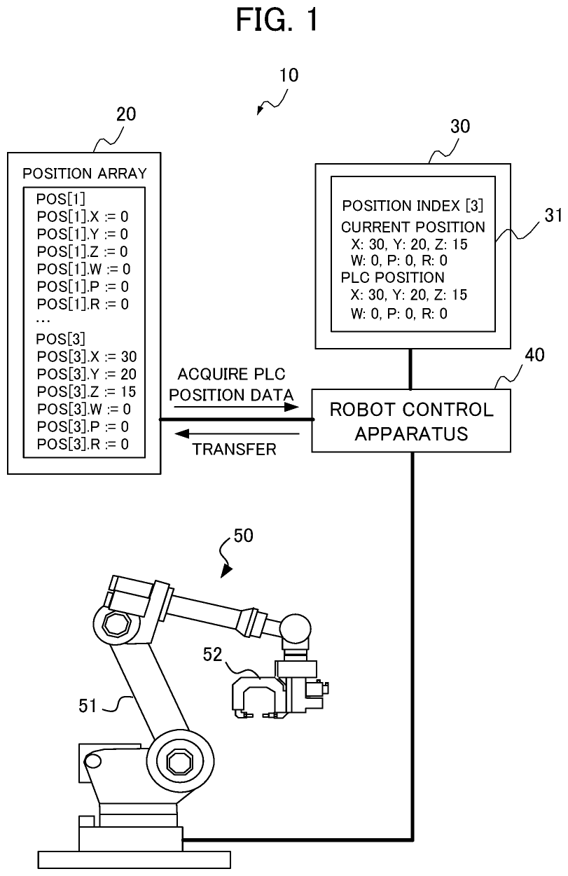

FIG. 1 is a block diagram showing a configuration example of a robot control system including a robot control apparatus of a first embodiment of the present disclosure.

As shown in FIG. 1, a robot control system 10 is provided with a PLC 20, a robot teaching operation panel 30, a robot control apparatus 40, and a robot 50. The robot control apparatus 40 is connected to the PLC 20, the robot teaching operation panel 30, and the robot 50. The robot teaching operation panel 30 may be provided as a part of the robot control apparatus 40. The PLC 20 specifies order of assembly work and the like performed by the robot 50, and outputs operation commands to the robot control apparatus 40. The robot control apparatus 40 controls the robot 50 based on the operation commands. The robot control apparatus 40 transfers the current position of the robot 50 to the PLC 20. The PLC 20 stores the current position into the PLC 20, and controls the robot 50 via the robot control apparatus 40 based on the current position.

In the PLC 20, a position array (to be a predetermined area) is prepared as an area for storing the current position of the robot 50. For example, as shown in FIG. 1, X=30, Y=20, Z=15, W=0, P=0, R=0 are stored in POS[3] of the position array of the PLC 20 as a current position of the robot 50. When the current position of the robot 50 is inputted from the robot control apparatus 40, and the inputted current position is different from the position stored in POS[3] of the position array of the PLC 20, then the PLC 20 overwrites the position stored in POS[3] of the position array of the PLC 20 with the inputted current position.

The robot teaching operation panel 30 is a device provided with a display function and an information input function, and is, for example, a touch-panel-equipped liquid crystal display device, or a liquid crystal display, a keyboard, and the like. The robot teaching operation panel 30 is provided with a screen 31. On the screen 31, a position index number is shown as a setting item, and which position array element of the PLC 20 the current position is to be stored into is specified by the position index number. Furthermore, the current position of the robot 50, a position stored in a position array element specified by the PLC 20 (a PLC position), and the like are displayed on the screen 31.

For example, in FIG. 1, on the screen 31 of the robot teaching operation panel 30, a position index [3] is displayed as the position index number, and X=30, Y=20, Z=15, W=0, P=0, R=0 are displayed as the current position of the robot 50. Further, on the screen of the robot teaching operation panel 30, X=30, Y=20, Z=15, W=0, P=0, R=0 are displayed as the PLC position. The PLC position is the same as the position stored in POS[3] of the position array of the PLC 20. Therefore, by looking at the screen of the robot teaching operation panel 30, the user can confirm that the current position of the robot 50 has been correctly stored in POS[3] of the position array of the PLC 20.

Using the robot teaching operation panel 30, the user gives a command to transfer the current position of the robot 50 to the PLC 20 and a command to acquire the position stored in the PLC 20 or related information about the position, from the PLC 20. The robot teaching operation panel 30 outputs the commands to the robot control apparatus 40 as operation signals.

The robot 50 is, for example, an articulated robot, and is provided with a robot mechanism unit 51 and an end factor 52 attached to the tip of the robot mechanism unit 51. The current position of the robot 50 is, for example, the position of the end factor 52 attached to the tip of the robot mechanism unit 51 of the robot 50. The robot mechanism unit 51 has a plurality of joint axes, for example, six joint axes in FIG. 1. Each joint axis is provided with a motor. The end factor 52 is, for example, a robot hand, a welding torch, a paint sprayer, and the like. Each motor is provided with a position detection unit, for example, an encoder. A position detection signal of the position detection unit of each joint axis is sent to the robot control apparatus 40.

The robot control apparatus 40 controls each of the motors of the plurality of joint axes of the robot mechanism unit 51 based on operation commands from the PLC 20. Further, the robot control apparatus 40 determines values of the current position (X, Y, Z, W, P, R) of the robot 50 from the position detection signal outputted from the robot mechanism unit 51 of the robot 50, and displays the values of the position (X, Y, Z, W, P, R) on the screen 31 of the robot teaching operation panel 30 as the current position.

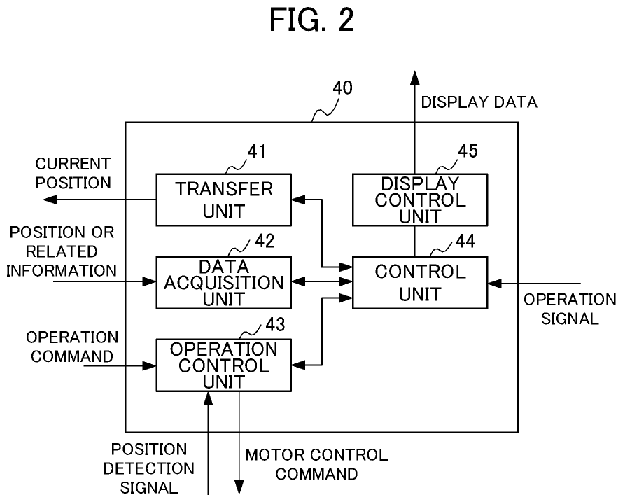

FIG. 2 is a block diagram showing a configuration of the robot control apparatus. As shown in FIG. 2, the robot control apparatus 40 is provided with a transfer unit 41, a data acquisition unit 42, an operation control unit 43, a control unit 44, and a display control unit 45.

If a transfer command is given from the control unit 44, the transfer unit 41 transfers X=30, Y=20, Z=15, W=0, P=0, R=0 indicating the current position of the robot 50, to the PLC 20. If a data acquisition command is given from the control unit 44, the data acquisition unit 42 acquires X=30, Y=20, Z=15, W=0, P=0, R=0 stored in POS[3] of the position array of the PLC 20, from the PLC 20.

Based on an operation command from the PLC 20, the operation control unit 43 outputs, in order to control each of the motors of the plurality of joint axes of the robot mechanism unit 51 of the robot 50, a motor control command for each motor to the robot 50. Further, the operation control unit 43 outputs a position detection signal of the position detection unit of each joint axis, to the control unit 44.

The control unit 44 determines values of the current position (X, Y, Z, W, P, R) of the robot 50 based on the position detection signal of the position detection unit of each joint axis, stores the current position, and outputs the current position to the display control unit 45. Further, if an operation signal received from the robot teaching operation panel 30 is an operation signal to transfer the current position of the robot 50 to the PLC 20, the control unit 44 outputs the stored current position to the transfer unit 41 together with a transfer command. If an operation signal received from the robot teaching operation panel 30 is an operation signal to acquire the position stored in the PLC 20 or related information about the position, from the PLC 20, the control unit 44 outputs a data acquisition command to the data acquisition unit 42. The display control unit 45 displays the values of the position (X, Y, Z, W, P, R) on the screen 31 of the robot teaching operation panel 30 as the current position.

The functional blocks included in the robot control apparatus 40 have been described above. In order to realize the functional blocks, the robot control apparatus 40 is provided with an arithmetic processing device such as a CPU (central processing unit). Further, the robot control apparatus 40 is also provided with an auxiliary storage device such as an HDD (hard disk drive) in which application software and various kinds of control programs such as an OS (operating system) are stored, and a main memory such as a RAM (random access memory) for storing data that is temporarily required for the arithmetic processing device to execute a program.

In the robot control apparatus 40, the arithmetic processing device reads application software and the OS from the auxiliary storage device, and performs arithmetic processing based on the read application software or OS while developing the application software or the OS on the main memory. Various kinds of hardware provided in each device are controlled based on a result of the arithmetic processing. Thereby, the functional blocks of the robot control apparatus 40 of the present embodiment are realized. That is, the present embodiment can be realized by hardware and software cooperating with each other.

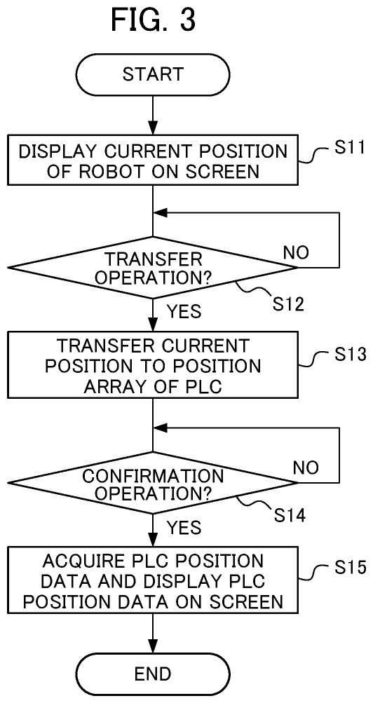

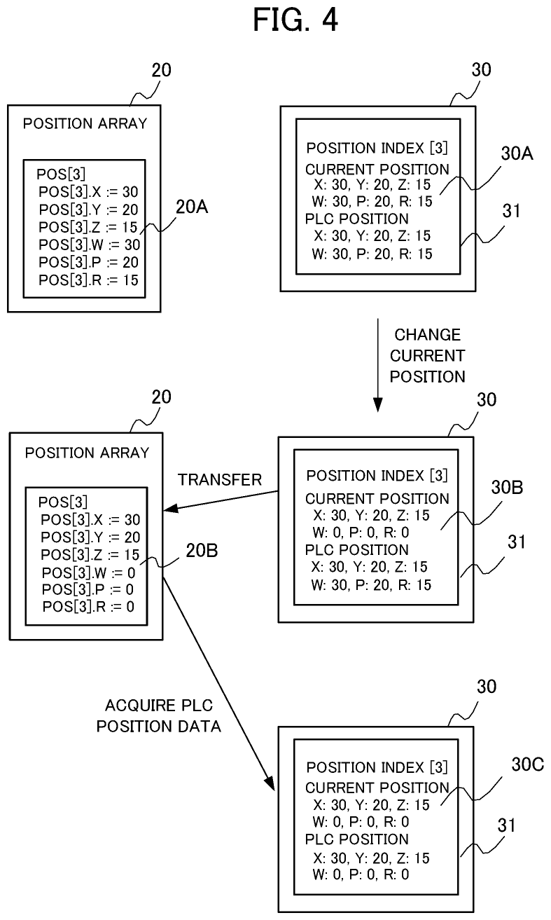

Description will be made below on operation of the robot control apparatus 40 when the current position of the robot 50 changes from X=30, Y=20, Z=15, W=30, P=20, R=15 to X=30, Y=20, Z=15, W=0, P=0, R=0 using FIGS. 3 and 4. FIG. 3 is a flowchart showing the operation of the robot control apparatus 40. FIG. 4 is a diagram showing change in display information on the screen of the robot teaching operation panel 30 and in storage information about a position array of the PLC 20.

It is assumed that, as shown in FIG. 4, X=30, Y=20, Z=15, W=30, P=20, R=15 are displayed as the current position of the robot 50, and X=30, Y=20, Z=15, W=30, P=20, R=15 are displayed as the PLC position on the screen 31 of the robot teaching operation panel 30 first. The display information on the screen 31 at this time is referred to as display information 30A. In POS[3] of the position array of the PLC 20, X=30, Y=20, Z=15, W=30, P=20, R=15 are stored. The storage information at this time is referred to as storage information 20A.

The robot control apparatus 40 causes the end factor 52 to rotate so that the position of the end factor 52 at the tip of the robot mechanism unit 51 of the robot 50 is indicated by X=30, Y=20, Z=15, W=0, P=0, R=0.

At Step S11 in FIG. 3, the robot control apparatus 40 changes the current position of the robot 50 from X=30, Y=20, Z=15, W=30, P=20, R=15 to X=30, Y=20, Z=15, W=0, P=0, R=0 based on a position detection signal from the robot 50, and displays the values on the screen 31 of the robot teaching operation panel 30. Then, the display information on the screen 31 changes from the display information 30A to display information 30B. Looking at the PLC position of the display information 30B on the screen 31, the user recognizes that X=30, Y=20, Z=15, W=30, P=20, R=15 are still stored in POS[3] of the position array of the PLC 20.

At Step S12, the robot control apparatus 40 detects whether a transfer operation on the robot teaching operation panel 30 has been performed by the user or not. The transfer operation is performed, for example, by the user pressing a transfer key not shown on the touch-panel-equipped liquid crystal display device of the robot teaching operation panel 30. If the transfer operation has been performed, the robot control apparatus 40 transitions to Step S13, and, otherwise, waits until the transfer operation is performed.

At Step S13, the robot control apparatus 40 transfers X=30, Y=20, Z=15, W=0, P=0, R=0 indicating the current position, to the PLC 20. The PLC 20 overwrites X=30, Y=20, Z=15, W=30, P=20, R=15 stored in POS[3] of the position array with X=30, Y=20, Z=15, W=0, P=0, R=0. Then, the storage information changes from the storage information 20A to storage information 20B.

At Step S14, the robot control apparatus 40 detects whether a PLC position data acquisition operation on the robot teaching operation panel 30 has been performed by the user or not. The position data acquisition operation is performed, for example, by the user selecting the position index [3] on the touch-panel-equipped liquid crystal display device of the robot teaching operation panel 30 and pressing a confirmation key not shown. If the position data acquisition operation has been performed, the robot control apparatus 40 transitions to Step S15, and, otherwise, waits until the position data acquisition operation is performed.

At Step S15, the robot control apparatus 40 acquires X=30, Y=20, Z=15, W=0, P=0, R=0 stored in POS[3] of the position array of the PLC 20. Then, the robot control apparatus 40 changes the PLC position on the screen 31 of the robot teaching operation panel 30 to X=30, Y=20, Z=15, W=0, P=0, R=0. The display information on the screen 31 changes from the display information 30B to display information 30C.

Looking at the display information 30C on the robot teaching operation panel 30, the user recognizes that X=30, Y=20, Z=15, W=0, P=0, R=0 have been stored into POS[3] of the position array of the PLC 20 by overwriting.

By the above operation, the user can confirm that the current position of the robot has been correctly stored in the position array of the PLC 20 by looking at the screen 31 of the robot teaching operation panel 30. As a result, the work of, after operating the robot teaching operation panel 30 to transfer the current position of the robot to the PLC 20, the user confirming whether the position has been stored or not on the screen of the PLC 20 becomes unnecessary.

### SECOND EMBODIMENT

In the first embodiment, by the user pressing the confirmation key not shown on the robot teaching operation panel 30, the PLC position stored in POS[3] of the position array of the PLC 20 is acquired and displayed on the robot teaching operation panel 30. In the present embodiment, by the user pressing the confirmation key not shown on the robot teaching operation panel 30, position-related information stored in the PLC 20 is acquired from the PLC 20 and displayed on the screen 31 of the robot teaching operation panel 30. The position-related information is, for example, the name of a PLC function block (FB) referring to the position of the robot, which is stored in the PLC, the line number of a line of a PLC program where the FB is shown, a comment about the FB, and the like.

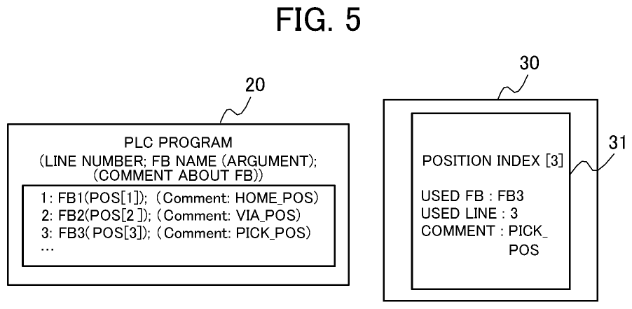

FIG. 5 is a diagram showing display information on the screen of the robot teaching operation panel 30 and storage information of the PLC 20. For example, when the user selects the position index [3] and presses the confirmation key not shown, the name of a PLC function block (FB) referring to POS[3], which is a position array element in the PLC 20, the line number of a line of the PLC program where the FB is shown, and a comment about the FB are acquired from the PLC 20 and displayed on the screen 31 of the robot teaching operation panel 30. Thereby, for example, that the position is referred to by an FB with the name of “FB3”, that the “FB3” is shown on the third line of the PLC program, and the like are known. When a comment and the like are attached to the FB, they are also displayed on the screen. In FIG. 5, “PICK POS” that means a picking position of the robot is displayed as the comment.

### THIRD EMBODIMENT

In the first embodiment, when the user presses the transfer key not shown on the robot teaching operation panel 30, the robot control apparatus 40 transfers the current position of the robot 50 to the PLC 20, and the PLC 20 overwrites a position stored in POS[3] of the position array with the current position transferred from the robot control apparatus 40. In the present embodiment, before overwriting the position stored in POS[3] of the position array with the current position transferred from the robot control apparatus 40, the PLC 20 asks the user whether or not to perform the overwriting.

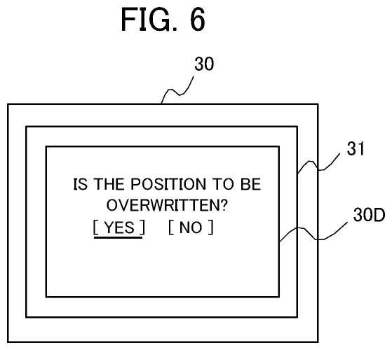

When an operation of transferring the current position of the robot to the PLC 20 is performed on the screen 31 of the robot teaching operation panel 30 by the user, the control unit 44 of the robot control apparatus 40 receives an operation signal. If a position is already stored in a specified position array element at the time of receiving the operation signal, the control unit 44 displays a confirmation popup 30D of a message “Is this position to be overwritten?” on the screen 31. FIG. 6 is a diagram showing the confirmation popup displayed on the screen 31. If the user selects “Yes”, it is possible to transfer the current position to the position array element to perform overwriting. If the user selects “No”, transfer is terminated, and the position in the position array element of the PLC 20 is not changed.

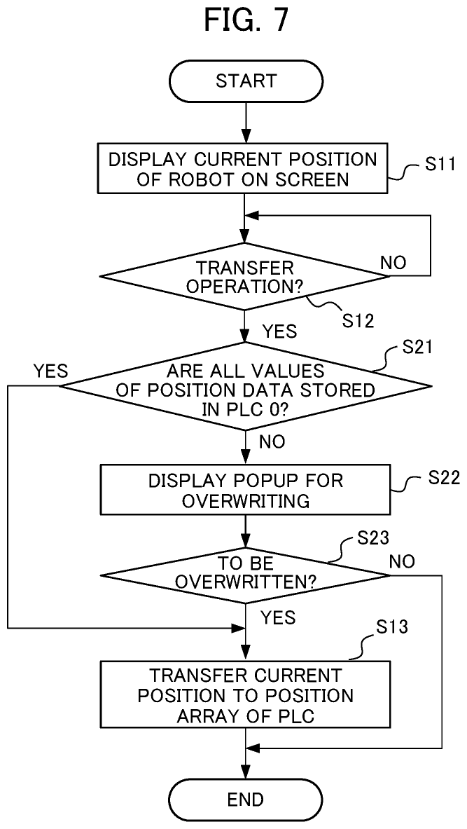

FIG. 7 is a flowchart showing operation of the robot control apparatus 40 of the third embodiment. In the flowchart of FIG. 7, three steps of Steps S21, S22, and S23 are provided between Steps S12 and S13 of the flowchart of FIG. 3. At Step S12, the robot control apparatus 40 detects whether a transfer operation on the robot teaching operation panel 30 has been performed by the user and, if the transfer operation has been performed, transitions to Step S21.

At Step S21, the robot control apparatus 40 acquires position data stored in a position array element of the PLC, and judges whether all values of the position data are “0” or not. The position data of the robot includes a posture in addition to X, Y, Z, W, P and R. Therefore, even if the values of X, Y, Z, W, P and R are “0”, all the values of the position data are not “0” because the value of the posture is included. Since all the initial values of position data stored in a position array element of the PLC are “0”, it can be judged that a transfer process has not been performed if all the values of the position data are “0”. Therefore, if all the values of the position data are “0”, the robot control apparatus 40 does not display the confirmation popup 30D on the screen because the transfer is the first transfer, transitions to Step S13, and transfers X=30, Y=20, Z=15, W=0, P=0, R=0 indicating the current position, to the PLC 20. On the other hand, if all the values of the position data are not “0”, the robot control apparatus 40 judges that a transfer process has already been performed, and transitions to Step S22.

At Step S22, the robot control apparatus 40 displays the confirmation popup 30D on the screen 31 of the robot teaching operation panel 30, and transitions to Step S23. If the user selects “Yes” at Step S23, the robot control apparatus 40 transitions to Step S13. If the user selects “No”, transfer is not performed, and the position in the position array element of the PLC 20 is not changed.

Each embodiment according to the present invention has been described above. Each component unit included in the robot control apparatus can be realized by hardware, software, or a combination thereof. Further, a robot control method performed in cooperation among the component units included in the robot control apparatus can also be realized by hard ware, software, or a combination thereof. Here, being realized by software means that being realized by a computer reading and executing a program.

The program can be supplied to the computer by being stored in any of various types of non-transitory computer-readable recording media. The non-transitory computer-readable recording media include various types of tangible storage media. Examples of the non-transitory computer-readable recording media include magnetic recording media (for example, a hard disk drive), magneto-optical recording media (for example, a magneto-optical disk), a CD-ROM (read-only memory), a CD-R, a CD-R/W, and semiconductor memories (for example, a mask ROM, a PROM (programmable ROM), an EPROM (erasable PROM), a flash ROM, and a RAM (random access memory)).

Though the embodiments described above are preferred embodiments of the present invention, the scope of the present invention is not limited only to the above embodiments, but the present invention can be practiced in embodiments in which various changes are made within a range not departing from the spirit of the present invention.

A robot control apparatus, a robot control system, and a robot control method by the present disclosure can take various embodiments having the following configurations including the embodiments described above.

(1) A robot control apparatus (for example, the robot control apparatus 40) connected to a programmable logic controller (for example, the PLC 20) to control a robot (for example, the robot 50), the robot control apparatus including:

a transfer unit (for example, the transfer unit 41) transferring a current position of the robot to the programmable logic controller to store the current position into a predetermined area in the programmable logic controller; an acquisition unit (for example, the data acquisition unit 42) acquiring, from the programmable logic controller, the current position stored in the programmable logic controller or related information about the current position; and a display control unit (for example, the display control unit 45) displaying the current position or the related information that has been acquired, on a screen of a robot teaching operation panel (for example, the robot teaching operation panel 30). According to the robot control apparatus, it becomes unnecessary to, at the time of transferring a current position of a robot to a PLC to store the current position, alternately perform a transfer operation on a robot teaching operation panel and a confirmation operation on the screen of the PLC, and it is possible to perform a series of operations only with the robot teaching operation panel.

(2) The robot control apparatus according to (1) above; wherein, when the current position stored in the programmable logic controller is being referred to by a function block in a programmable logic controller program, the acquisition unit acquires information about the function block, and the display control unit displays the information on the screen of the robot teaching operation panel.

(3) The robot control apparatus according to (1) or (2) above, wherein, if the current position is already stored in the predetermined area when the current position is transferred to the programmable logic controller, a popup confirming whether or not to overwrite the current position is displayed on the screen of the robot teaching operation panel.

(4) The robot control apparatus according to any of (1) to (3) above, including the robot teaching operation panel.

(5) A robot control system including the robot control apparatus according to any of (1) to (4) above (for example, the robot control apparatus) and a programmable logic controller connected to the robot control apparatus. According to the robot control system, it becomes unnecessary to, at the time of transferring a current position of a robot to a PLC to store the current position, alternately perform a transfer operation on a robot teaching operation panel and a confirmation operation on the screen of the PLC, and it is possible to perform a series of operations only with the robot teaching operation panel.

(6) A robot control method for controlling a robot using a programmable logic controller (for example, the PLC 20) and a robot control apparatus (for example, the robot control apparatus 40) connected to the programmable logic controller, the robot control method including: the robot control apparatus transferring a current position of the robot to the programmable logic controller to store the current position into a predetermined area in the programmable logic controller; the robot control apparatus acquiring, from the programmable logic controller, the current position stored in the programmable logic controller or related information about the current position; and the robot control apparatus displaying the current position or the related information that has been acquired, on a screen of a robot teaching operation panel. According to the robot control method, it becomes unnecessary to, at the time of transferring a current position of a robot to a PLC to store the current position, alternately perform a transfer operation on a robot teaching operation panel and a confirmation operation on the screen of the PLC, and it is possible to perform a series of operations only with the robot teaching operation panel.

### EXPLANATION OF REFERENCE NUMERALS

10 Robot control system
20 PLC
30 Robot teaching operation panel
40 Robot control apparatus
41 Transfer unit
42 Data acquisition unit
43 Operation control unit
44 Control unit
45 Display control unit
50 Robot
51 Robot mechanism unit
52 End factor

1. A robot control apparatus connected to a programmable logic controller to control a robot, the robot control apparatus comprising:
a transfer unit transferring a current position of the robot to the programmable logic controller to store the current position into a predetermined area in the programmable logic controller;
an acquisition unit acquiring, from the programmable logic controller, the current position stored in the programmable logic controller or related information about the current position; and
a display control unit displaying the current position or the related information that has been acquired, on a screen of a robot teaching operation panel.

2. The robot control apparatus according to claim 1, wherein, when the current position stored in the programmable logic controller is being referred to by a function block in a programmable logic controller program, the acquisition unit acquires information about the function block, and the display control unit displays the information on the screen of the robot teaching operation panel.

3. The robot control apparatus according to claim 1 or 2, wherein, if the current position is already stored in the predetermined area when the current position is transferred to the programmable logic controller, a popup confirming whether or not to overwrite the current position is displayed on the screen of the robot teaching operation panel.

4. The robot control apparatus according to any one of claims 1 to 3, comprising the robot teaching operation panel.

5. A robot control system comprising the robot control apparatus according to any one of claims 1 to 4 and a programmable logic controller connected to the robot control apparatus.

6. A robot control method for controlling a robot using a programmable logic controller and a robot control apparatus connected to the programmable logic controller, the robot control method comprising:
the robot control apparatus transferring a current position of the robot to the programmable logic controller to store the current position into a predetermined area in the programmable logic controller;
the robot control apparatus acquiring, from the programmable logic controller, the current position stored in the programmable logic controller or related information about the current position; and
the robot control apparatus displaying the current position or the related information that has been acquired, on a screen of a robot teaching operation panel.

1. A robot control apparatus connected to a programmable logic controller to control a robot, the robot control apparatus comprising:
a transfer unit transferring a current position of the robot to the programmable logic controller to store the current position into a predetermined area in the programmable logic controller;
an acquisition unit acquiring, from the programmable logic controller, the current position stored in the programmable logic controller or related information about the current position; and
a display control unit displaying the current position or the related information that has been acquired, on a screen of a robot teaching operation panel.

2. The robot control apparatus according to claim 1, wherein, when the current position stored in the programmable logic controller is being referred to by a function block in a programmable logic controller program, the acquisition unit acquires information about the function block, and the display control unit displays the information on the screen of the robot teaching operation panel.

3. The robot control apparatus according to claim 1, wherein, if the current position is already stored in the predetermined area when the current position is transferred to the programmable logic controller, a popup confirming whether or not to overwrite the current position is displayed on the screen of the robot teaching operation panel.

4. The robot control apparatus according to claim 1, comprising the robot teaching operation panel.

5. A robot control system comprising the robot control apparatus according to claim 1 and a programmable logic controller connected to the robot control apparatus.

6. A robot control method for controlling a robot using a programmable logic controller and a robot control apparatus connected to the programmable logic controller, the robot control method comprising:
the robot control apparatus transferring a current position of the robot to the programmable logic controller to store the current position into a predetermined area in the programmable logic controller;
the robot control apparatus acquiring, from the programmable logic controller, the current position stored in the programmable logic controller or related information about the current position; and
the robot control apparatus displaying the current position or the related information that has been acquired, on a screen of a robot teaching operation panel.
